(19) United States
(12) Patent Application Publication
(10) Pub. No.: US 2004/0257408 A1
(43) Pub. Date: Dec. 23, 2004

(54) Method and device for ejecting micro-drops of liquid

(75) Inventor: Marco Pizzi, Torino (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI

(21) Appl. No.: 10/869,881

(22) Filed: Jun. 18, 2004

(30) Foreign Application Priority Data
Jun. 20, 2003 (IT) TO2003A000467

(51) Int. Cl. B41J 2/135

(52) U.S. Cl. 347/68

(57) ABSTRACT

Method for ejecting micro-drops of liquid, including the steps of providing a body (18) equipped with at least one passage (30) communicating with a tank (12) of liquid (14), and producing in the passage (30) a choke or a widening that is moveable along a direction of ejection (46), in such a way as to produce the ejection of controlled quantities of liquid (48) from one end (34) of said passage (30).

The present invention relates to a method and device for ejecting micro-drops of liquid.

Systems for the controlled ejection of micro-drops of liquid are used in particular in ink jet printing systems. The most widely used systems for the controlled ejection of micro-drops of ink can be divided in two fundamental groups: thermal ejection systems and piezoelectric ejection systems. Thermal ink jet actuators are based on the principle of generating a steam bubble which causes the acceleration of a fluid in a chamber. In piezoelectric ejection actuators, the movement of a piezoelectric electric element is used to change the volume of a chamber or the displacement of a fluid to cause the acceleration of the fluid. Thermal ejection systems can be produced with fine pitch, up to 300 dpi or better. The principle of steam generation, however, requires the use of water or fluids with similar behaviour, which entails a severe limitation for possible technical applications, since only a few types of fluid can be used.

Actuators based on the piezoelectric principles can be used with a high variety of types of ink and have the advantage of a long duration. The use of piezoelectric materials is particularly suitable for a broad class of fluid control systems, such as micro-pumps and micro-valves.

The object of the present invention is to develop a new class of devices for controlling the fluid flow based on the use of a porous means, or a means with micro-channels, actively controlled.

According to the present invention, said object is achieved by a method and by a device for ejecting micro-drops having the characteristics set out in the claims.

The present invention shall now be described in detail with reference to the accompanying drawings, provided purely by way of non limiting example, in which:

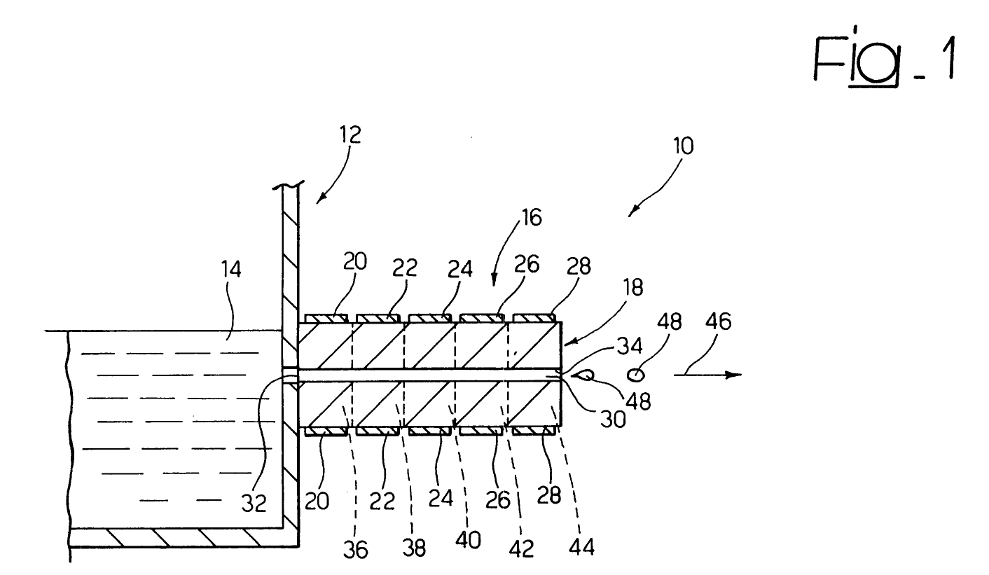

FIG. 1 is a schematic section view of a device according to the present invention, and

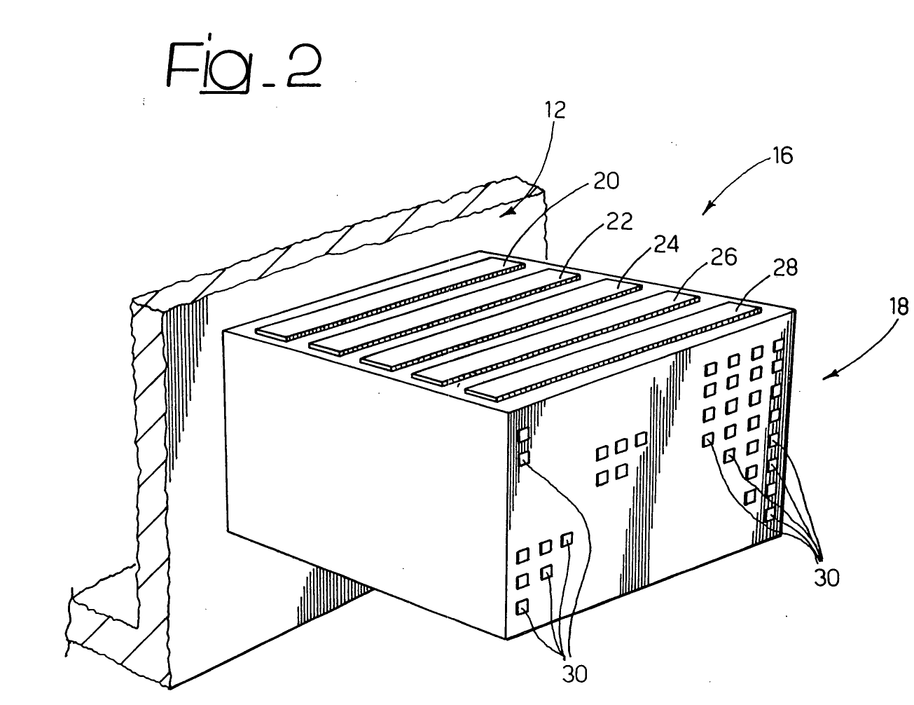

FIG. 2 is a perspective view of a variant of a device according to the invention.

With reference to FIG. 1, the number 10 designates a device for ejecting micro-drops of liquid according to the present invention. The device 10 comprises a tank 12, containing a liquid 14, and a piezoelectric actuator 16. The piezoelectric actuator 16 comprises a body 18 made of piezoelectric material and a plurality of electrodes designated by the references 20, 22, 24, 26 and 28.

The body of piezoelectric material 18 has at least one passage 30 having a first end 32 which communicates with the interior of the tank 12 and a second end 34 open on a front surface of the body 18. The passage 30 can be constituted by a micro-channel or by the porosity of the body 18. The passage 30 fills with liquid by capillary action and it is normally full of liquid from the tank 12.

In the example illustrated in FIG. 1, the passage 30 extends along a rectilinear direction. The electrodes 20, 22, 24, 26 and 28 follow each other in the direction of the axis of the passage 30. The electrodes 20-28 are approached to each other and are applied on the external surface of the body of piezoelectric material 18. In a variant not shown herein, the electrodes 20-28 could be incorporated in the body of piezoelectric material.

The electrodes 20-28 are connected to a source of electric power supply (not shown herein) driven in such a way as to activate in succession the electrodes 20-28. The activation in succession of the electrodes causes the excitation in succession of different areas of the body of piezoelectric material 18. In FIG. 1, the different areas of the body 18 are delimited by dashed lines, orthogonal to the axis of the passage 30 and designated by the reference numbers 36, 38, 40, 42 and 44. The number of the areas of the body of piezoelectric material 18 correspond to the number of the electrodes 20-28 able to be activated independently of each other. The number of the electrodes and of the areas of the body 18 which can be excited in sequence may vary starting from a minimum of 2.

The excitation in succession of the different areas 36-44 of the body causes a choke or a widening (according to the particular configuration of the electrodes and to the voltage applied) in the passage 30 which moves along the axis of the passage 30, in the direction indicated by the arrow 46 in FIG. 1. Said travelling choke or widening causes the ejection of controlled quantities of liquid. The liquid is ejected through the open end 34 of the body 18 in the form of micro-drops 48. Each micro-drop 48 has a volume in the order of a picolitre.

The piezoelectric actuator 16 is capable of operating at high frequencies, in the order of a kHz or of MHz. The passage 30 in the form of channels or micro-porosities of the material has capillary dimensions, so that in the absence of excitation the liquid does not flow out spontaneously.

FIG. 2 schematically shows an embodiment of the invention which constitutes an extension of the concept illustrated in FIG. 1. In the variant of FIG. 2, the body of piezoelectric material 18 is provided with a plurality of micro-channels 30 arranged for example according to a matrix configuration. The micro-channels 30 can be activated simultaneously by activating electrodes 20, 22, 24, 26 and 28 in succession. The electrodes can also be distributed inside the body 18 in such a way that each micro-channel 30 is associated to a respective series of electrodes. In this way, it is possible to activate individually each of the micro-channels 30 independently from the others, in order to obtain the ejection of micro-drops in any point of the matrix.

The body 18, instead of being entirely constituted by piezoelectric material, could be formed by a substrate of inert material bearing the passage or the passages for the ejection of the liquid drops and a layer of piezoelectric material applied on the inert material or incorporated in the inert material.

Naturally, without altering the principle of the invention, the construction details and the embodiments may be widely varied relative to what is described and illustrated herein, without thereby departing from the scope of the present invention as defined in the appended claims.

What is claimed is:

1. A method for ejecting micro-drops of liquid, comprising the steps of:
providing a body fitted with at least one passage communication with a tank of a liquid, and
producing in the passage a movable choke or widening along a direction of ejection, in such a way as to cause the ejection of controlled quantities of liquid from one end of said passage.

2. Method as claimed in claim 1, wherein the body is constituted by piezoelectric material.

3. Method as claimed in claim 1, wherein the body is associated to elements of piezoelectric material applied on the body or incorporated in the body.

4. Method as claimed in claim 20, wherein the movable choke of widening is produced by sequentially exciting different areas of the piezoelectric material.

5. Method as claimed in claim 4, wherein the excitation of the different areas of piezoelectric material is obtained by sequentially activation a plurality of electrodes approached to each other along said direction of ejection

6. Device for ejecting micro-drops of liquid, comprising:
an actuator including a body provided with at least one passage communicating with a tank of liquid, and
means to produce in the passage a choke or a widening that is movable along a direction of ejection, in such a way as to cause the ejection of controlled quantities of liquid from one end of said passage.

7. Device as claimed in claim 6, wherein the body is made of piezoelectric material.

8. Device as claimed in claim 6, wherein the body comprises elements of piezoelectric material applied on the body or incorporated in the body.

9. Device as claimed in claim 7, comprising a plurality of electrodes for exciting in succession different areas of the piezoelectric material.

10. Device as claimed in claim 6, wherein the passage has capillary dimensions.

11. Device as claimed in claim 6, wherein the body comprises a plurality of passages arranged according to a matrix configuration

12. Device as claimed in claim 11, wherein each of said passages is associated to a respective series of electrodes.

13. Device as claimed in claim 12, wherein each of said series of electrodes can be activated in succession independently of the series of electrodes associated to the other passages.
